(19) United States
(12) Patent Application Publication
(10) Pub. No.: US 2013/0007796 A1
(43) Pub. Date: Jan. 3, 2013

(54) SYSTEM AND METHOD FOR BLOCKING ACCESS TO PROGRAMS USING A PARENTAL LOCK MENU

(75) Inventors: Brian CHEN, Taoyuan County (TW); Terry WU, Taoyuan City (TW)

(73) Assignee: TOP VICTORY INVESTMENTS LIMITED, Kwun Tong (HK)

(21) Appl. No.: 13/537,296

(22) Filed: Jun. 29, 2012

(30) Foreign Application Priority Data
Jun. 30, 2011 (TW) 100123140

(51) Int. Cl. H04N 21/25

(52) U.S. Cl. 725/28

(57) ABSTRACT

A system for blocking access to programs includes a display device, an on-screen display (OSD) unit, a memory unit, and a filter unit. The OSD unit is operable to control the display device to display a main-rating menu having multiple main-rating options arranged in one dimension. At least one main-rating option is associated with a sub-rating menu that is displayed when the corresponding main-rating option is selected. The sub-rating menu has multiple sub-rating options arranged for display in the same dimension as the main-rating options. The memory unit stores information of which rating is intended to be blocked. The filter unit is to block or allow access to the programs based upon the stored information.

### CROSS-REFERENCE TO RELATED APPLICATION

This application claims priority to Taiwanese Application No. 100123140, filed on Jun. 30, 2011.

### BACKGROUND OF THE INVENTION

1. Field of the Invention

The invention relates to a system and a method for blocking access to programs, and more particularly to a system and a method for blocking access to programs that are suitable for application to a display with a small display area.

2. Description of the Related Art

In order to prevent exposure of children to TV programs having violent and/or sexual content, it is legislated that a television must be installed with a V-chip in the United States, which determines program ratings for audience according to the program contents.

Using main-rating codes for example, the programs are rated into six ratings based on properness to children and teenagers, and a sub-rating code may be further added to the programs for providing the parents with additional detail. The ratings are described as follows.

1. TV-Y—All ages 2 and older: These programs are not expected to frighten younger children.

2. TV-Y7—Directed to children aged 7 years or older: Children at this age may be able to distinguish between reality and performance. Shows with this rating may contain crude or suggestive humor, mild fantasy violence, or content considered too frightening to be shown to children less than seven years of age. This rating has an alternate version TV-Y7-FV. The sub-rating code “FV” refers to “fantasy violence”.

3. TV-G—General audience: Programs are suitable for viewing by children without parental guidance. Shows with this rating should contain inoffensive content, mild language, and non-sexual conversations or situations.

4. TV-PG—Parental guidance suggested: The rating signifies that the program may be unsuited for younger children without guidance of a parent. The sub-rating codes of this rating include V for moderate violence, S for sexual situations, L for infrequent coarse language, and D for suggestive dialogue.

5. TV-14—Parents strongly cautioned/May be unsuited for children under 14 years of age: The sub-rating codes of this rating include V for intense violence, S for intense sexual situations, L for strong coarse language, and D for intensely suggestive dialogue.

6. TV-MA—Mature audience—unsuited for audiences under 17 years of age: The sub-rating codes of this rating include V for graphic violence, S for explicit sexual activity, and L for crude indecent language.

In a conventional parental lock menu, which is displayed in two-dimension arrangement, the main-rating codes and the sub-rating codes are arranged in a fixed table format, thereby resulting in requirement of a large display area.

### SUMMARY OF THE INVENTION

Therefore, an object of the present invention is to provide a system and a method for blocking access to programs that are suitable for application to a relatively small display area.

According to one aspect of the present invention, a system for blocking access to programs comprises:

an input device;

a display device;

an on-screen display (OSD) unit operable to control the display device to display a main-rating menu of a parental lock menu according to a menu display command from the input device, the main-rating menu having a plurality of main-rating options arranged for display in one dimension, at least one of the main-rating options being associated with a respective sub-rating menu that is displayed on the display device in response to an input command from the input device when the corresponding one of the main-rating options is selected, the sub-rating menu having a plurality of sub-rating options arranged for display in the same one dimension as the main-rating options of the main-rating menu;

a memory unit for storing information of at least one of the main-rating options and the sub-rating options selected through a select command from the input device and corresponding to at least one program, access to which is intended to be blocked; and

a filter unit operable to block or allow access to the programs based upon the information stored in the memory unit.

According to another aspect of the present invention, a method for blocking access to programs comprises:

a) displaying a main-rating menu of a parental lock menu on a display device according to a menu display command, the main-rating menu having a plurality of main-rating options arranged for display in one dimension;

b) in response to an input command for one of the main-rating options that is associated with a respective sub-rating menu, displaying the sub-rating menu on the display device, the sub-rating menu having a plurality of sub-rating options arranged for display in the same one dimension as the main-rating options of the main-rating menu;

c) in response to a select command for one of the main-rating options and the sub-rating options that corresponds to at least one program, access to which is intended to be blocked, storing information of said one of the main-rating options and the sub-rating options in a memory unit; and

d) blocking or allowing access to the programs based upon the information stored in the memory unit.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram showing a preferred embodiment of the system for blocking access to programs according to the present invention;

FIG. 2 is a schematic diagram showing a main-rating menu of a first embodiment of the method according to the present invention;

FIG. 3 is a schematic diagram showing a sub-rating menu of the first embodiment;

FIG. 4 is a schematic diagram showing a blocking-enabled marker in a check box associated with a selected sub-rating option in the first embodiment;

FIG. 5 is a schematic diagram showing a main-rating menu of a second embodiment of the method according to the present invention;

FIG. 6 is a schematic diagram showing a main-rating menu and a sub-rating menu of the second embodiment; and

FIG. 7 is a schematic diagram showing a blocking-enabled marker in a check box associated with a selected sub-rating option in the second embodiment.

### DETAILED DESCRIPTION OF THE PREFERRED EMBODIMENTS

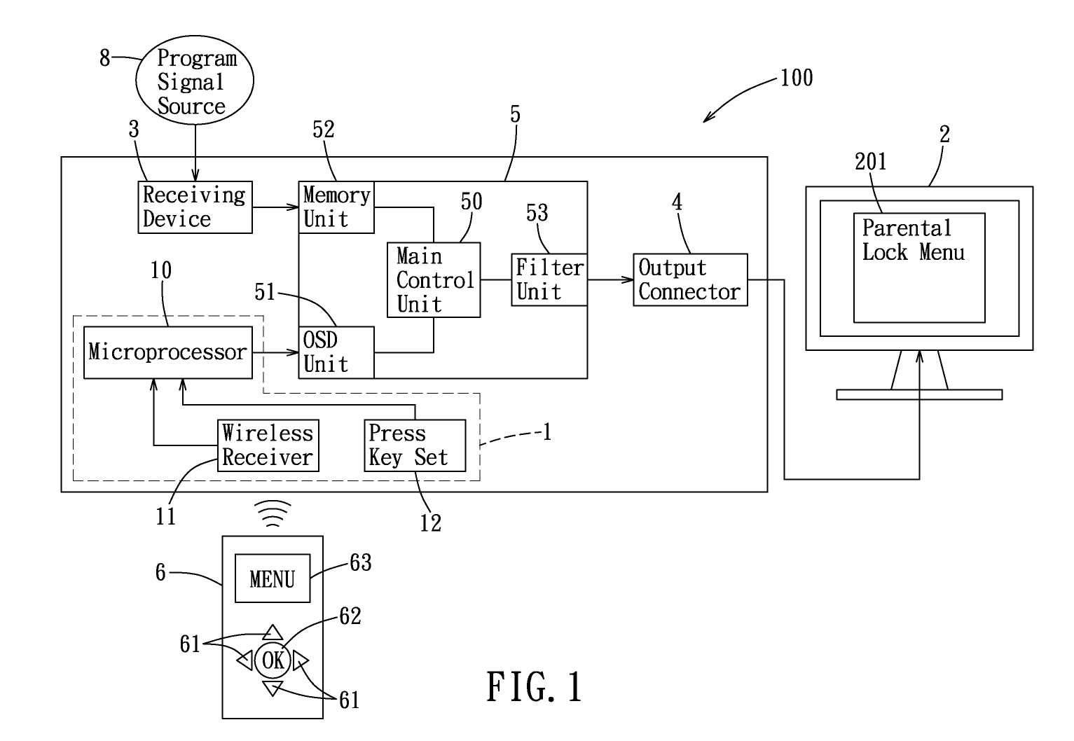

Referring to FIG. 1, the preferred embodiment of the system 100 for blocking access to programs according to this invention is shown to include an input device 1, a display device 2, a receiving device 3, an output connector 4, and a control device 5, and is configured for use with a remote controller 6. The remote controller 6 has four arrow keys 61, a select key 62, and a menu key 63.

The receiving device 3 is an analog-to-digital converter operable to convert a received analog signal from a program signal source 8 into a digital signal to be provided to the control device 5. The output connector 4 is an LVDS (low-voltage differential signal) video output connector driven by the control device 5 to output a display signal to the display device 2. When the menu key 63 of the remote controller 6 is pressed to display a menu and an appropriate option therein is selected, a parental lock menu 201 is displayed on the display device 2.

The input device 1 is for receiving commands inputted by a user, such as input commands representing four directions associated with the arrow keys 61, or a select command associated with the select key 62. In this embodiment, the input device 1 has a microprocessor 10, a wireless receiver 11, and a press key set 12. The wireless receiver 11 is used to receive the input command generated upon pressing the arrow keys 61 of the remote controller 6, or the select command generated upon pressing the select key 62 of the remote controller 6. The press key set 12 has similar press keys operable to generate the input command or the select command provided to the microprocessor 10. Thereafter, the microprocessor 10 notifies the control device 5 of the operation intended by the user.

The control device 5 is coupled to the input device 1, the receiving device 3, and the output connector 4, and is coupled to the display device 2 via the output connector 4. The control device 5 includes a main control unit 50, an on-screen display (OSD) unit 51, a memory unit 52, and a filter unit 53. After the receiving unit 3 converts the analog signal into a digital signal provided to the control device 5, the main control unit 50 controls the memory unit 52 to store the digital data therein, and obtains rating information from the digital data. The rating information contains at least a rating code of a program. The rating code of the program may be not rated, a main-rating code without a sub-rating code, or a main-rating code with a sub-rating code.

In this preferred embodiment, the main-rating code is one of age-related rating codes, which include TV-Y, TV-Y7, TV-G, TV-PG, TV-14, and TV-MA. The sub-rating code is one of content-related rating codes, which include FV for fantasy violence, V for violence, S for sexual situations, L for coarse language, and D for suggestive dialogue.

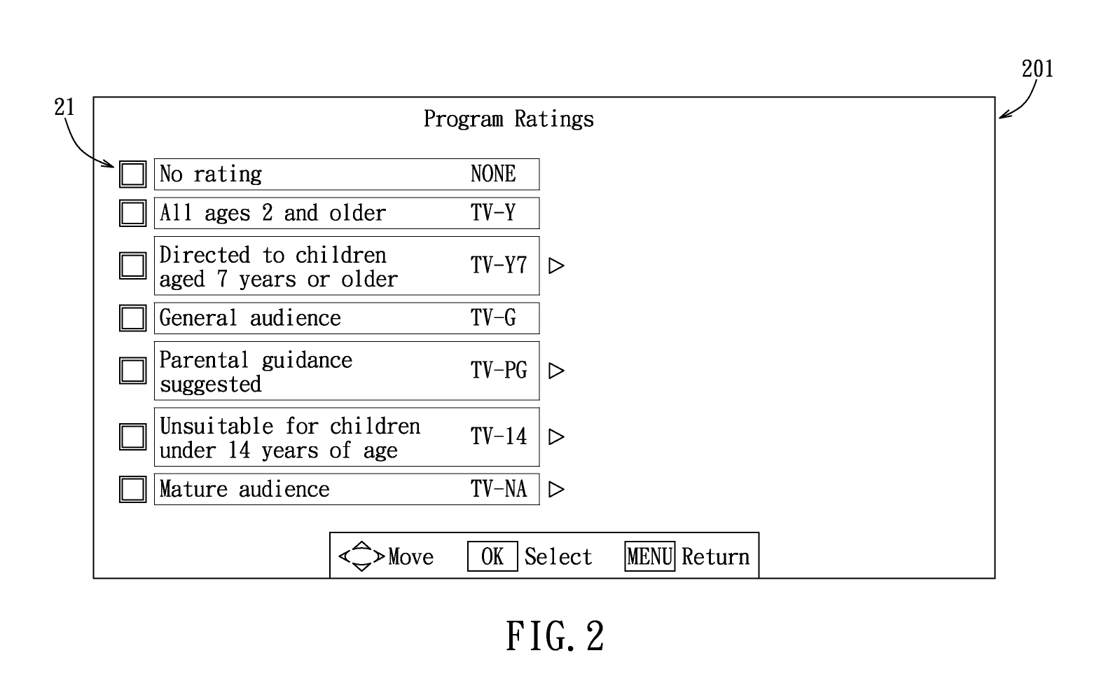

Referring to FIG. 1 and FIG. 2, the display device 2 is operable to display the parental lock menu 201. The parental lock menu 201 has a main-rating menu 21. The main-rating menu 21 has a plurality of main-rating options arranged for display in one dimension. Except for the “No rating” option, each of the main-rating options in this preferred embodiment corresponds to one of the age-related rating codes including TV-Y, TV-Y7, TV-G, TV-PG, TV-14, and TV-MA.

Referring to FIG. 1 to FIG. 4, the operation flow of a first embodiment of the method for blocking access to programs using the system 100 will now be described.

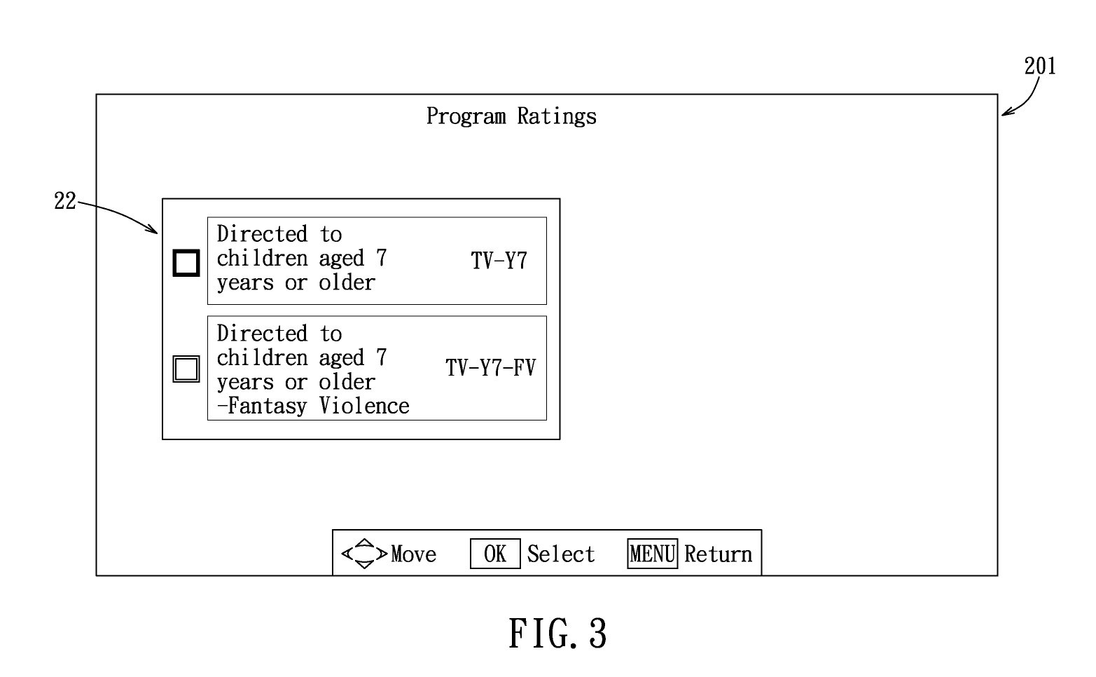

After notification of the user's operation (such as pressing the menu key 63) through the microprocessor 10, the on-screen display (OSD) unit 51 controls the display device 2 to display an OSD menu (not shown), and to display a main-rating menu 21 of the parental lock menu 201 according to further receipt of a menu display command from the input device 1. Among the main-rating options, at least one of the main-rating options is associated with a respective sub-rating menu 22. The respective sub-rating menu 22 is displayed on the display device 2 in a pop-up manner when the corresponding main-rating option is selected by the user through user operation (such as pressing a right arrow key 61) and through the input device 1 for generating the input command, as shown in FIG. 3. It should be noted that, in this embodiment, only one of the main-rating menu 21 and the sub-rating menu 22 is displayed at a time, as shown in FIG. 2 or FIG. 3. In this embodiment, the main-rating menu 21 and the sub-rating menu 22 are displayed on the same display area of the display device 2, to thereby reduce the display area occupied by the parental lock menu 201.

Referring to FIG. 3, the sub-rating menu 22 has a plurality of sub-rating options (such as TV-Y7, TV-Y7-FV) arranged for display in the same one dimension as the main-rating options of the main-rating menu 21. In this invention, one of a column number and a row number of the parental lock menu 201 does not exceed two when the parental lock menu 201 is shown on the display device 2. When the sub-rating menu 22 is displayed, one of the sub-rating options is highlighted, such as the check box associated with the sub-rating option TV-Y7 is shown in a darkened state in FIG. 3.

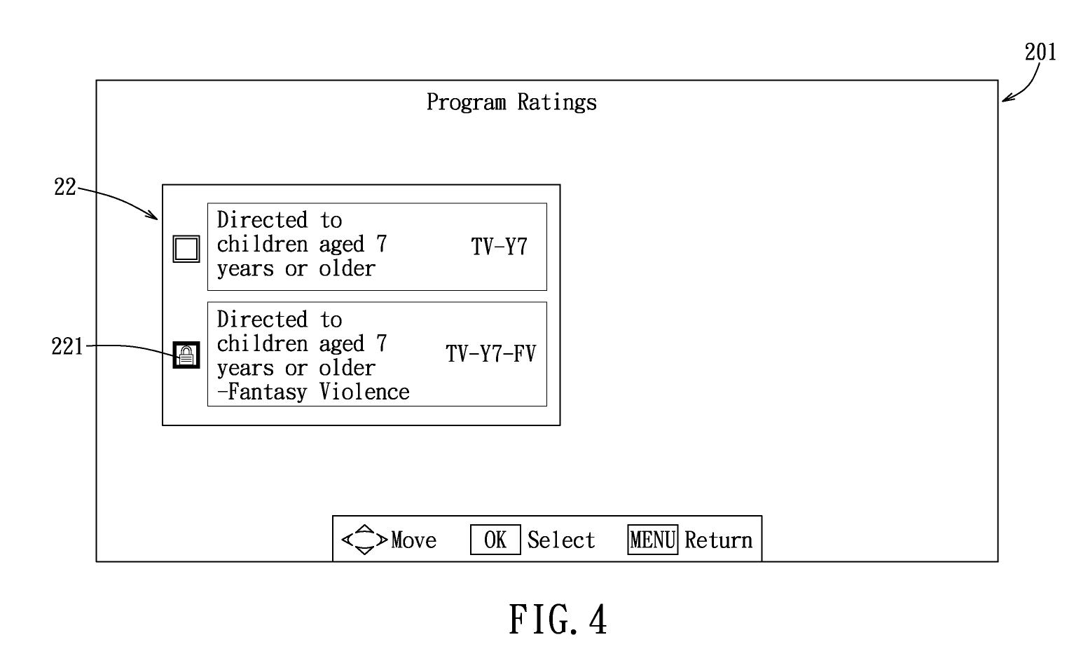

Referring to FIG. 4, upon receiving the select command (such as by pressing the select key 62), the highlighted sub-rating option (such as TV-Y7-FV) is locked, and the locked sub-rating option is displayed together with a blocking-enabled marker 221.

Referring to FIG. 1, when the lock setting is completed on the parental lock menu 201, the main control unit 50 is operable to store in the memory unit information of the main-rating option or the sub-rating option selected by the user and corresponding to the programs, access to which is intended to be blocked by the user. In this embodiment, when the main control unit 50 receives the digital signal from the receiving device 3, the main control unit 50 is operable to determine whether the rating information from the digital signal has the sub-rating code corresponding to one of the locked sub-rating options (such as TV-Y7-FV) according to the stored information in the memory unit 52. The filter unit 53 is controlled by the main control unit 50 to block those programs having the sub-rating code corresponding to one of the locked sub-rating options.

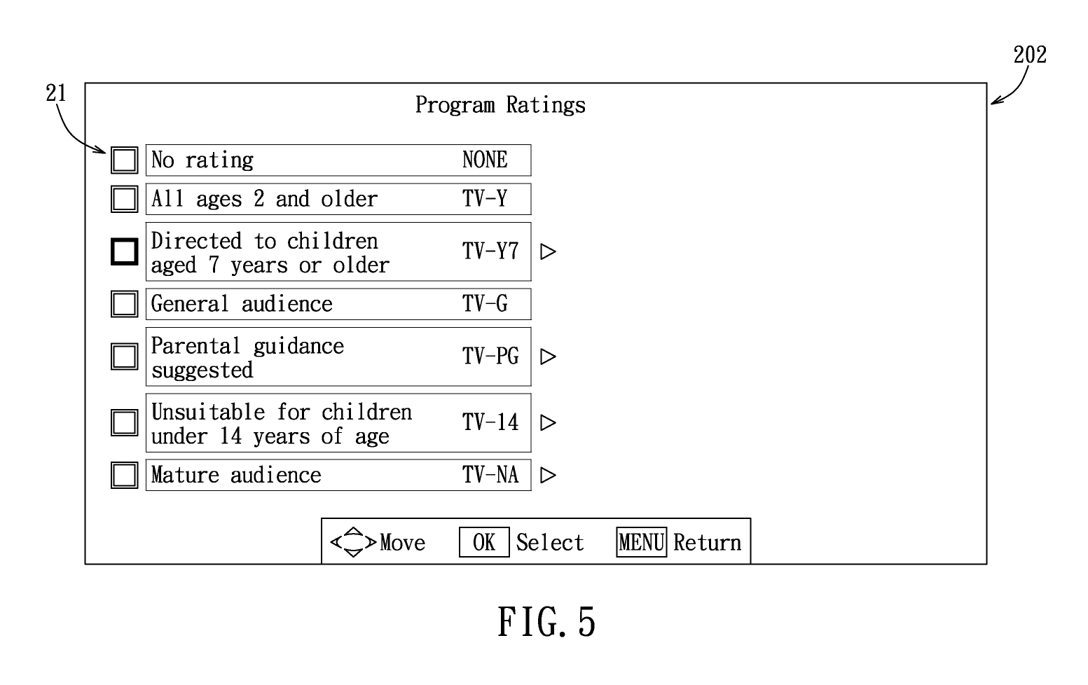

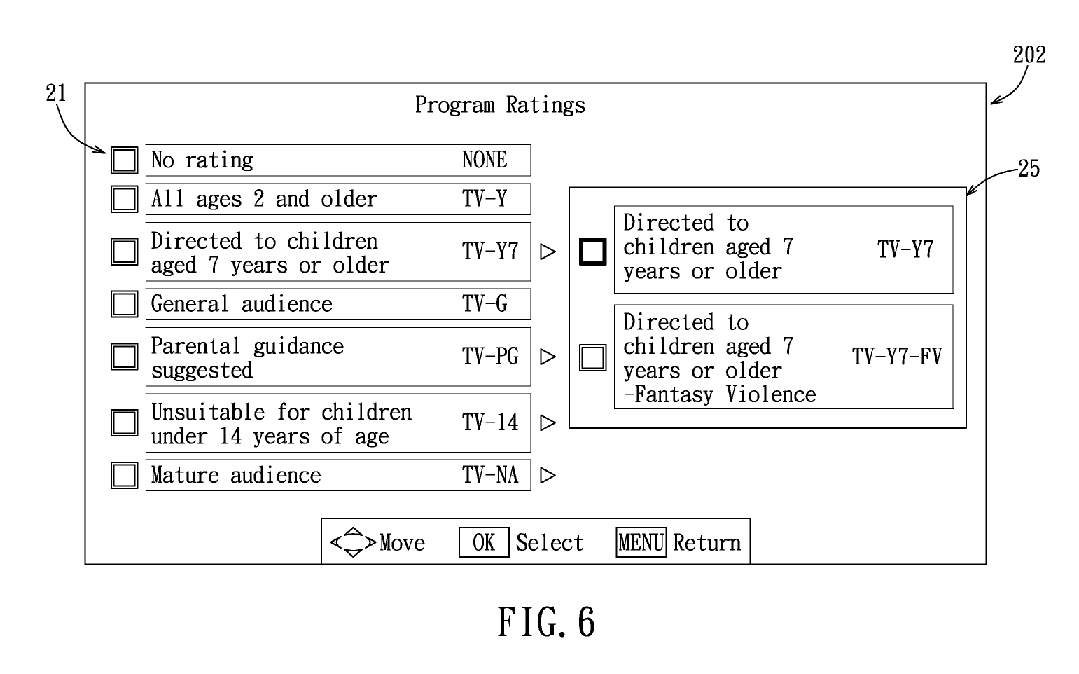

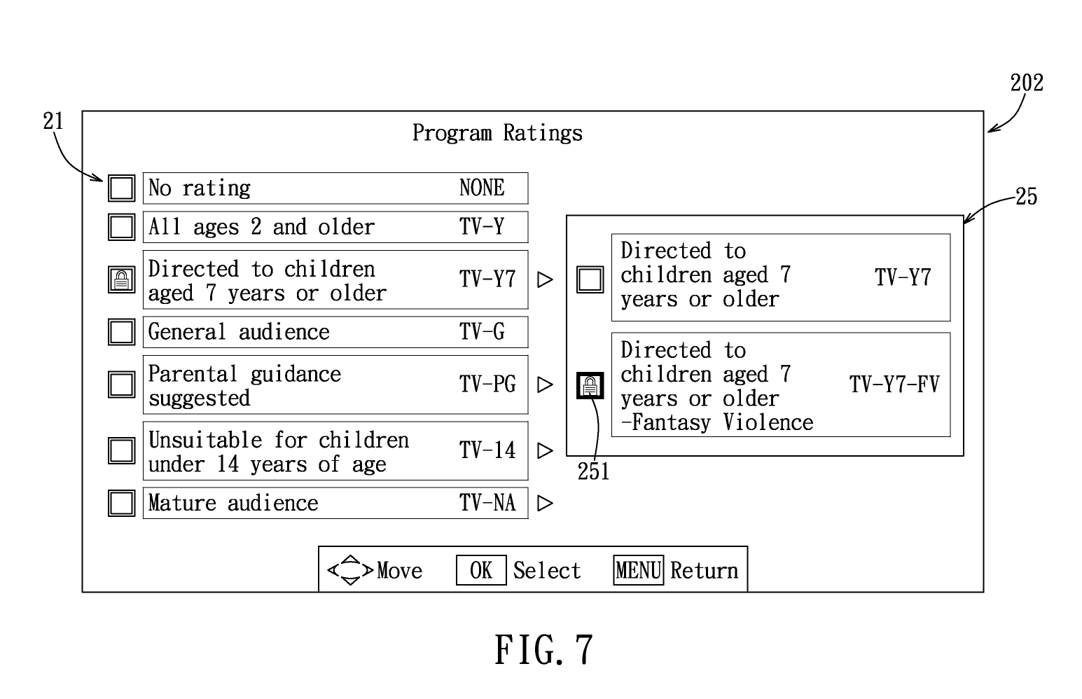

Referring to FIG. 5 to FIG. 7, together with FIG. 1, in a second embodiment of the method according to the present invention, when the parental lock menu 202 is displayed on the display device 2, the OSD unit 51 is operable to have the main-rating menu 21 and one of the sub-rating menus 25 displayed simultaneously side-by-side on the display device 2 when one of the main-rating options associated with a respective sub-rating menu 25 is selected, as shown in FIG. 6 and FIG. 7. In this embodiment, the sub-rating menu 25 is a side menu, and the main-rating menu 21 is displayed on a left-side area of the parental lock menu 202 with the sub-rating menu 25 being displayed side-by-side. Compared to the conventional fixed menu, one of a column number and a row number of the parental lock menu 202 does not exceed two when the parental lock menu 202 is shown on the display device 2, to thereby reduce the display area.

In this embodiment, after notification of the user's operation (such as pressing the menu key 63) through the microprocessor 10, the on-screen display (OSD) unit 51 controls the display device 2 to display an OSD menu (not shown), and to display a main-rating menu 21 of the parental lock menu 202 according to further receipt of a menu display command from the input device 1. Among the main-rating options, at least one of the main-rating options is associated with a respective sub-rating menu 25. The respective sub-rating menu 25 is displayed on the display device 2 when the corresponding main-rating option is selected by the user through user operation (such as a right arrow key 61) and through the input device 1 for generating an input command. The sub-rating menu 25 has a plurality of sub-rating options (such as TV-Y7, TV-Y7-FV) arranged for display in the same one dimension as the main-rating options of the main-rating menu 21, and one of a column number and a row number of the parental lock menu 202 does not exceed two when the parental lock menu 202 is shown on the display device 2. When the sub-rating menu 25 is displayed, one of the sub-rating options is highlighted. Upon receiving a select command (such as by pressing the select key 62), the highlighted sub-rating option (such as TV-Y7-FV) is locked. In this embodiment, the locked sub-rating option is displayed together with a blocking-enabled marker 251, as shown in FIG. 7. When the sub-rating option (such as TV-Y7-FV) is locked, the associated main-rating option is also displayed together with the blocking-enabled marker 251, so as to remind the user that at least one of the sub-rating options corresponding to the main-rating option is locked. When the lock setting is completed on the parental lock menu 202, the main control unit 50 is operable to store in the memory unit information of the main-rating option or the sub-rating option selected by the user and corresponding to the programs, access to which is intended to be blocked by the user. In this embodiment, when the main control unit 50 receives the digital signal from the receiving device 3, the main control unit 50 is operable to determine whether the rating information in the digital signal has the sub-rating code corresponding to one of the locked sub-rating options (such as TV-Y7-FV) according to the stored information in the memory unit 52. The filter unit 53 is controlled by the main control unit 50 to block those programs having the sub-rating code corresponding to one of the locked sub-rating options.

It should be noted that once a higher rating is locked, the lower ratings should also be locked. For example, when the rating TV-Y is locked, the ratings TV-Y7, TV-G, TV-PG, TV-14, and TV-MA are also locked. Moreover, when a locked rating is unlocked, the higher ratings should also be unlocked. For example, when the rating TV-14 is unlocked, all other ratings except for TV-MA should be unlocked too. Additionally, the main-rating menu 21 may have a no rating option, such that when the user intends to unlock all ratings, by selecting the no rating option, previous selection of the main-rating options 21 and the sub-rating options 22, 25 is cleared for allowing access to all of the programs.

To sum up, the sub-rating menu 22, 25 of the parental lock menu 201, 202 of this invention has a plurality of sub-rating options arranged for display in the same one dimension as the main-rating options of the main-rating menu 21. Moreover, one of a column number and a row number of the parental lock menu 201, 202 does not exceed two in a manner of a pop-up menu or a side menu, to thereby reduce the display area occupied by the parental lock menu so as to be suitable for application to a display device with a small display area.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A system for blocking access to programs, comprising:
an input device;
a display device;
an on-screen display (OSD) unit operable to control said display device to display a main-rating menu of a parental lock menu according to a menu display command from said input device, said main-rating menu having a plurality of main-rating options arranged for display in one dimension, at least one of said main-rating options being associated with a respective sub-rating menu that is displayed on said display device in response to an input command from said input device when the corresponding one of said main-rating options is selected, said sub-rating menu having a plurality of sub-rating options arranged for display in the same one dimension as said main-rating options of said main-rating menu;
a memory unit for storing information of at least one of said main-rating options and said sub-rating options selected through a select command from said input device and corresponding to at least one program, access to which is intended to be blocked; and
a filter unit operable to block or allow access to the programs based upon the information stored in said memory unit.

2. The system as claimed in claim 1, wherein one of a column number and a row number of said parental lock menu does not exceed two when said parental lock menu is shown on said display device.

3. The system as claimed in claim 1, wherein, when said parental lock menu is displayed on said display device, only one of said main-rating menu and said sub-rating menu is displayed at a time.

4. The system as claimed in claim 3, wherein said main-rating menu and said sub-rating menu are displayed on the same display area of said display device.

5. The system as claimed in claim 1, wherein, when said sub-rating menu is displayed on said display device, said main-rating menu and said sub-rating menu are displayed simultaneously side-by-side on said display device.

6. The system as claimed in claim 1, wherein said main-rating options of said main-rating menu are associated with age-related rating codes, and said sub-rating options of said sub-rating menu are associated with content-related rating codes.

7. The system as claimed in claim 1, wherein each of said main-rating options and said sub-rating options selected for blocking access to the at least one program corresponding thereto is displayed together with a blocking-enabled marker on said display device.

8. The system as claimed in claim 7, wherein said blocking-enabled marker is shown in a check box associated with the respective one of said main-rating options and said sub-rating options.

9. The system as claimed in claim 1, wherein said main-rating menu further has a no rating option which, when selected, clears previous selection of said main-rating options and said sub-rating options for allowing access to all of the programs.

10. A method for blocking access to programs, comprising:
a) displaying a main-rating menu of a parental lock menu on a display device according to a menu display command, the main-rating menu having a plurality of main-rating options arranged for display in one dimension;
b) in response to an input command for one of the main-rating options that is associated with a respective sub-rating menu, displaying the sub-rating menu on the display device, the sub-rating menu having a plurality of sub-rating options arranged for display in the same one dimension as the main-rating options of the main-rating menu;
c) in response to a select command for one of the main-rating options and the sub-rating options that corresponds to at least one program, access to which is intended to be blocked, storing information of said one of the main-rating options and the sub-rating options in a memory unit; and
d) blocking or allowing access to the programs based upon the information stored in the memory unit.

11. The method as claimed in claim 10, wherein one of a column number and a row number of the parental lock menu does not exceed two when the parental lock menu is shown on the display device.

12. The method as claimed in claim 10, wherein, when the parental lock menu is displayed on the display device, only one of the main-rating menu and the sub-rating menu is displayed at a time.

13. The method as claimed in claim 12, wherein the main-rating menu and the sub-rating menu are displayed on the same display area of said display device.

14. The method as claimed in claim 10, wherein, when the sub-rating menu is displayed on the display device, the main-rating menu and the sub-rating menu are displayed simultaneously side-by-side on the display device.

15. The method as claimed in claim 10, wherein the main-rating options of the main-rating menu are associated with age-related rating codes, and the sub-rating options of the sub-rating menu are associated with content-related rating codes.

16. The method as claimed in claim 10, wherein each of the main-rating options and the sub-rating options selected for blocking access to the at least one program corresponding thereto is displayed together with a blocking-enabled marker on the display device.

17. The method as claimed in claim 16, wherein the blocking-enabled marker is shown in a check box associated with the respective one of the main-rating options and the sub-rating options.

18. The method as claimed in claim 10, wherein the main-rating menu further has a no rating option which, when selected, clears previous selection of the main-rating options and the sub-rating options for allowing access to all of the programs.
